(19) United States
(12) Patent Application Publication
(10) Pub. No.: US 2020/0324534 A1
(43) Pub. Date: Oct. 15, 2020

(54) HEAT BUILD-UP AND COLOR FADE RESISTANT VINYL EXTRUDATE PANEL

(71) Applicant: Ply Gem Industries, Inc., Cay, NC (US)

(72) Inventors: Danny R. Parks, Blue Springs, MO (US); Eric B. Dickey, Overland Park, KS (US); Leland F. Harris, Plattsburg, MO (US)

(21) Appl. No.: 16/845,331

(22) Filed: Apr. 10, 2020

Related U.S. Application Data
(60) Provisional application No. 62/832,460, filed on Apr. 11, 2019.

(51) Int. Cl. B32B 27/30

(52) U.S. Cl. CPC B32B 27/304; B32B 2307/712; B32B 2307/71; B32B 2307/306; B32B 2307/416; B32B 2264/104; B32B 2419/00; B32B 2307/732

(57) ABSTRACT

Disclosed herein is a multi-layer polymer panel resistant to heat build-up and color fading. The panel includes a first exterior facing, polymer layer formulated from polyvinylidene difluoride that is in the range of about 90-99% opaque. In addition, a second layer is formulated from polyvinyl chloride and additives. A third layer is positioned beneath the middle layer wherein the third layer is comprised of a formulation in the range of about 60-70% by weight polyvinyl chloride and in the range of about 20-30% by weight poly(a-methylstyrene-styrene-acrylonitrile).

### CROSS-REFERENCE TO RELATED APPLICATIONS

This application claims priority to U.S. Provisional Application No. 62/832,460 filed on Apr. 11, 2019, the entirety of which is incorporated herein by reference.

### FIELD OF DISCLOSURE

This disclosure relates in general to a heat buildup resistant and color fade resistant extruded polymer panel comprising an exterior facing first polymer layer and an infrared light reflective second layer disposed beneath the first layer. The panel further includes a third layer disposed beneath the second layer.

### BACKGROUND

Vinyl siding has a very large market penetration and has been the most used siding product on new single-family homes in the U.S. every year since 1994. It was applied to roughly 35% of all new homes built during that time frame. The majority of new vinyl sided homes are in the south (40%), mid-west (35%), and northeast (19%) (U.S. Census Bureau 2009). Based on sales data and projections from 1999 to 2019, approximately 45% of residential vinyl siding is, or will be, used in the new construction market; the remainder will be used for retrofits and repairs (Freedonia-Group, Inc. 2009). Principia Residential Siding & Trim Report (Principia Consulting LLC) forecasts North American vinyl siding demand to be 34% of all cladding types used for new construction and repair & remodel by 2016. Key markets are expected to continue showing strong demand for vinyl siding versus other cladding types (e.g. Mid-Atlantic region—44% vinyl siding demand, East North Central region—43% and New England region 42%).

Two problems that continue to challenge the vinyl siding industry are (a) color fade due to exposure to intense sunlight over time and (b) thermal distortion due not only from direct warming by the sun but also due to reflection of sunlight from adjacent glass surfaces that concentrate the heat in a localized fashion and can substantially degrade the vinyl siding.

Consumers value the ability of vinyl siding to maintain its appearance after years of exposure to the elements and, more specifically, its ability to resist objectionable color change over its expected lifetime. ASTM D7856 titled Specification for Color and Appearance Retention of Solid Colored Plastic Siding Products provides a rigorous method for verifying that the original color is retained within reasonable time limits. This standard provides a standardized and consistent method of measuring and evaluating the degree of color change occurring in siding products after a period of outdoor exposure. It includes limits on the acceptable amount of color change based on perceptual studies of color change tolerances for different classifications, or regions, of colors.

PVC products for many years were available only in white plus shades of beige and gray. Siding panels and window profiles in dark colors, such as “Hunter Green” and “Dark Red,” have long been demanded in the industry. Still, there is the significant issue of heat build-up, which largely accounts for the relative lack of dark colors in PVC siding and other products formed of extrudates.

When referring to dark colors herein, the reference is generally to colors with an L* value between 13 and 40 per ASTM 4726-02. It is well known in the vinyl siding industry that PVC siding will fail in unacceptably high numbers, exhibiting symptoms such as buckling, warping and sagging, if the siding become too hot. The environmental factors typically causing a siding panel to warm is a high ambient air temperature in addition to visible light and near infrared solar radiation. ASTM standards D4803 titled, Predicted Heat Build-Up, and WK47658 titled, Standard test method for using reflectance spectra to produce an index of temperature rise in polymeric siding, are good predictors of product performance related to heat induced PVC siding failure.

### SUMMARY

These and other objects of the present invention, which will become apparent hereinafter, are achieved by providing a heat build-up resistant and a fade resistant extrudate of the type described.

It is therefore an object of the extruded panel disclosed herein to provide a heat build-up resistant panel comprised of a first, exterior facing, polymer layer of a formulation of polyvinylidene difluoride that is in the range of about 90-99% opaque. The panel further includes a second layer comprising a formulation of polyvinyl chloride and additives, as well as a third layer positioned beneath the second layer wherein the third layer is comprised of a formulation in the range of about 60-70% by weight polyvinyl chloride and in the range of about 20-30% by weight poly(a-methylstyrene-styrene-acrylonitrile).

The extrudate further exhibiting a predicted heat build-up as measured according to ASTM D4803 or ASTM WK47658, of less than about 50° F. This ASTM test method covers prediction of the heat buildup in rigid and flexible PVC building products above ambient air temperature, relative to black, which occurs due to absorption of the sun's energy.

These, together with other aspects of the disclosed technology, along with the various features of novelty that characterize the technology, are pointed out with particularity in the claims annexed hereto and form a part of this disclosed technology. For a better understanding of the disclosed technology, its operating advantages and the specific objects attained by its uses, reference should be made to the accompanying drawings and descriptive matter in which there are illustrated exemplary embodiments of the disclosed technology.

### BRIEF DESCRIPTION OF THE DRAWINGS

Illustrative embodiments of the disclosed technology are described in detail below with reference to the attached drawing figures, which are incorporated by reference herein and wherein:

FIG. 1 is a side elevation view of insulating glass lites in an insulating glass unit at equilibrium and evenly spaced apart;

FIG. 2 is a side elevation view of insulating glass lites in an insulating glass unit flexing outwardly due to temperature and pressure changes in the environment;

FIG. 3 is a side elevation view of insulating glass lites in an insulating glass unit flexing inwardly due to temperature and pressure changes in the environment;

FIG. 4 is an elevation view of an opposite wall condition detailing how the sun's energy is reflected off an insulating glass lite onto vinyl siding installed on an opposing wall of a neighboring structure;

FIG. 5 is a plan view illustrating how a vinyl siding clad inside corner can be exposed to solar energy reflected from an insulating glass lite in an insulating glass unit;

FIG. 6 is perspective view of an embodiment of a segment of vinyl siding incorporating the disclosures herein; and

FIG. 7 is a cross sectional view of the siding panel taken along line 7-7 in FIG. 6.

### DETAILED DESCRIPTION

With many hundreds of vinyl siding colors available to consumers, colors along with style and cost are the most discussed consideration in vinyl siding selection. Most manufacturers of vinyl siding include a color retention certification that allows the manufacturer to verify that their solid and multi-hued colors meet or exceed the requirements of ASTM D7856, the standards for solid color or multi-hued vinyl siding color retention.

The CIELAB is a color scale based on the Opponent-Color Theory. The L*, a*, b* color space includes all perceivable colors. One of the most important attributes of the L* a*b* model is device independence which means that the colors are defined independent of their nature of creation or the device they are displayed on.

The CIELAB is a color scale based on the Opponent-Color Theory. This theory assumes that the receptors in the human eye perceive color as the following pairs of opposites.

L* scale: light vs. dark where a low number (0-50) indicates dark and a high number (51-100) indicates light.

a* scale: Red vs. green where a positive number indicates red and a negative number indicates green.

b* scale: Yellow vs. blue where a positive number indicates yellow and a negative number indicates blue.

The delta values (dL*, da*, and db*) indicate how much a standard and sample differ from one another in L*, a* and b*. The dL*, da*, and db* values are often used for quality control or formula adjustment. d values that are out of tolerance indicate that there is too much difference between the standard and the sample, such as in evaluating the fade of a polymer object after years of exposure to sunlight and the environment. The type of correction needed may be determined by which delta value is out of tolerance. For example, if Δa is out of tolerance, the redness/greenness needs to be adjusted. Whether the sample is more red or green than the standard is indicated by the sign of the delta value. For example, if Δa is positive, the sample is redder than the standard. The total color difference, ΔE, may also be calculated. ΔE is a single value that takes into account the difference between the L*, a* and b* of the sample and the standard. It does not indicate which parameter is out of tolerance if AF is out of tolerance. The CIE L*, a*, b* color scale can be used on any object, including vinyl siding, whose color may be measured.

Vinyl siding manufacturers currently define excess fade, due to normal weathering (exposure to sunlight, and extremes of weather and atmosphere which will cause any colored surface to gradually fade, chalk, or accumulate dirt or stains), as a change in color, calculated according to ASTM D2244. Under this standard, a color spectrophotometer is used to measure the CIE L*, a*, and b* color values for test specimens. After the spectrometer is calibrated using a white tile reflectance standard, a measurement is made with a color standard tile for gauge, reliability, and reproducibility. Four color measurements are taken on each test specimen in an area free from defects. The average value for the four measurements is then used to determine if the total color change, ΔE, is greater than the manufacturer's established color fade value. The process of assessing the color change is done in accordance with ASTM standard D7856. The ΔE is typically referred to as color units or Hunter units.

THERMAL DISTORTION OF VINYL SIDING: Vinyl siding is often selected as an exterior cladding material because of its low maintenance and low cost qualities. However, there are several considerations that need to be taken into account when using vinyl siding products because vinyl siding products undergo heat deflection in the range of 142°-192° F. with an average distortion temperature of 166° F. according to a Lawrence Berkley National Laboratory Research Report titled “Research Needs: Glass Solar Reflectance and Vinyl Siding”; R. Hart, et. al, July 2011. Vinyl siding is available in a variety of colors with related solar absorptance levels (a measure of the proportion of solar radiation a body absorbs). In general, the darker the color, the more absorptive the siding. The absorptance values can range from 20% to 80%. The more absorptive the vinyl siding, the faster its temperature will increase when exposed to thermal energy or solar irradiance. There is a direct correlation between vinyl siding solar absorptance and the heating of the vinyl siding above the ambient air temperature.

The majority, approximately 51%, of solar energy to which exterior building materials are typically exposed is in the infrared (IR) spectrum. Because of this, absorptance in the IR spectrum has the greatest impact on the quantity of solar energy a material absorbs. Carbon black, a common black pigment, absorbs approximately 95% of solar IR, therefore alternative pigments with more favorable reflectance in the IR range are almost always used in vinyl siding. For comparison, titanium dioxide, an often-used white pigment, absorbs approximately 20% of solar IR. As noted above, darker colors will absorb more energy and have greater heat build-up. However, even for two materials with the same apparent color, the heat build-up may vary because of the specific pigment system used and its absorptance in the IR range.

With no sun on the siding, the vinyl siding temperature is the same as the ambient air temperature. At 20% and 40% solar absorptance, vinyl siding is able to withstand greater exposure to solar irradiance before distorting, than darker vinyl siding at 60% and 80% solar absorptance. The maximum direct solar irradiance normal to the sun for a given location, on a clear day, with the sun highest in sky, is approximately 1000 W/m². This level of solar irradiance is often referred to as “one sun”. However, the orientation of the sun relative to the siding will lessen the intensity of the solar irradiance due to the sun's angle of incidence. The solar irradiance experienced by the siding will vary with location, time of day and weather conditions, but a typical “corrected one sun” value for the irradiance on a vertical wall, is approximately 750 W/m².

Current testing requirements for the vinyl siding industry are per ASTM D3679, Standard Specification for Rigid Poly (Vinyl Chloride) (PVC) Siding. Vinyl siding meeting this standard is verified to meet weathering performance, color, gloss, windload resistance (withstanding wind pressures of at least 110 mph), surface distortion, impact resistance, flammability, heat shrinkage, linear expansion, camber, length, width and thickness. However, ASTM D3679 has a maximum test level of 120° F. This is significantly below the temperature that vinyl siding can experience when exposed to direct sunlight. In ASTM D4803-10, Standard Test Method for Predicting Heat Buildup in PVC Building Products and ASTM WK47658 Standard Test method for Using Reflectance Spectra to Produce an Index of Temperature Rise in Polymeric Siding, it is recognized that the sun can cause PVC building products to distort. Under section 5.1 Significance and Use, ASTM standard D4803-10 provides that heat buildup in PVC exterior building products due to absorption of the energy from the sun may lead to distortion problems. Heat build-up is affected by the color, emittance, absorptance, and reflectance of a product.

The heat build-up due to the absorption of solar energy in materials for outdoor application can be measured based upon data obtained by experimentally determining the total solar reflectance (TSR) and the temperature rise above ambient temperature under an ultraviolet heat lamp, relative to carbon black according to ASTM D4803 and ASTM WK47658 Standard Test method for Using Reflectance Spectra to Produce an Index of Temperature Rise in Polymeric Siding.

The challenges associated with darker siding color and distortion have only become more pronounced with the advent of Energy efficient low emissivity (“Low-E”) units comprised of two lites of glass separated by a spacer bar. Frequently, one lite of glass is coated with a Low-E coating that serves two functions: 1) reflects out the sun's short wave infrared energy in summer; and 2) reflect and keep in the home's long wave infrared energy in winter. These windows work by reflecting a greater percentage of sunlight, especially in the infrared “heat” wavelengths. Insulating glass units are made of two or more panes of glass that are hermetically sealed at the edge, trapping an insulating layer of air or other gas in between. When the pressure between the panes of glass is different from the atmospheric pressure, the glass is designed to bend slightly. When the glass deflects inward, this creates a concave reflective surface that concentrates the reflected beam of sunlight. Objects in the path of the beam may be subjected to temperatures well in excess of those from normal exposure to the sun.

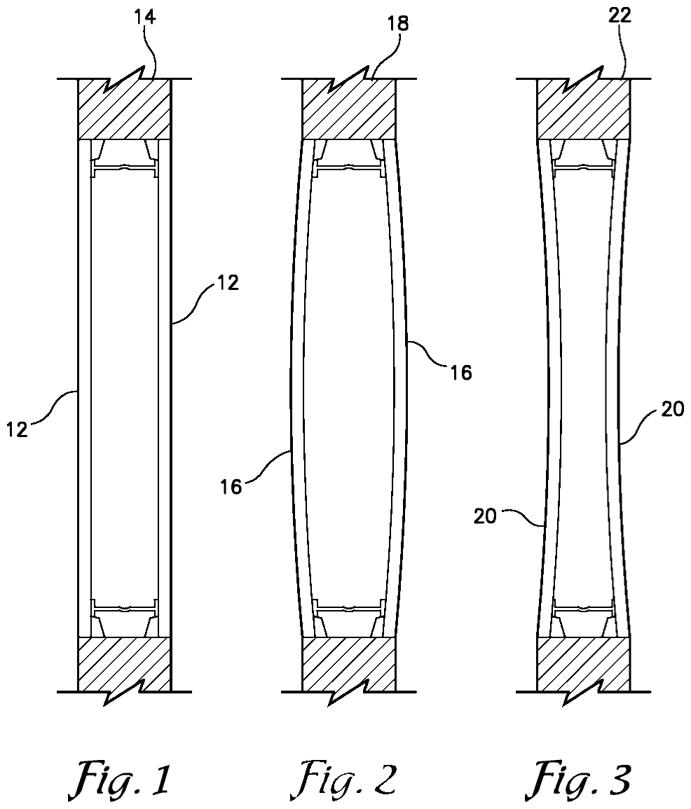

FIG. 1 depicts an insulating glass lites 12 in an insulating glass unit 14 where the glass lites 12 are equidistant from one another. FIG. 2 depicts the insulating glass lites 16 in an insulating glass unit 18 where the glass lites 16 are bowing away from one another. FIG. 3 depicts the insulating glass lites 20 in an insulating glass unit 22 where the glass lites 20 are bowing inward toward one another.

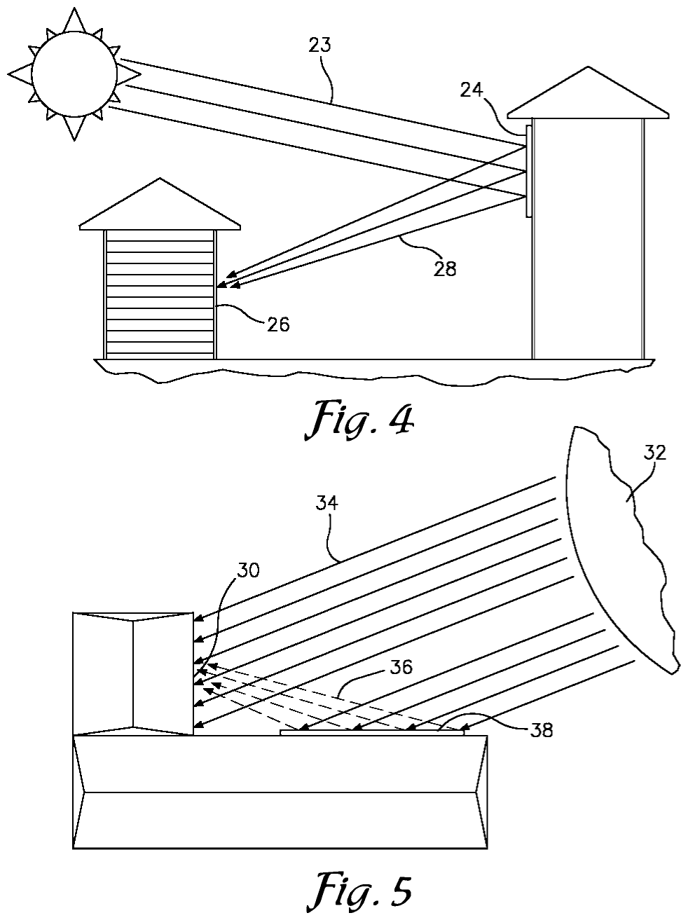

The dynamic flexing of insulating glass lites 16, 20 that may be seen in an insulating glass unit due to temperature and pressure changes in the environment. Most instances of vinyl siding distortion fall into one of two categories: opposite wall condition and inside corner condition. Opposite Wall Condition is illustrated in FIG. 4 and reveals how the sun's energy 23 can be reflected off a window 24 or door onto vinyl siding installed on an opposing wall 26 of a neighboring structure (“opposite wall condition”). In this scenario, the solar energy 28 is reflecting off the glass of the insulating glass unit 24. When solar energy is reflected off of an insulating glass unit with no or minimal deflection, the resulting reflection stays in relatively parallel lines and does not concentrate. As the amount of deflection increases, as seen with the glass lites in FIG. 3, the reflected energy becomes more concentrated, resulting in higher temperatures where the light rays converge.

FIG. 5 illustrates how a vinyl siding clad inside corner 30 can be exposed to solar energy. In this situation, the vinyl siding 30 receives direct exposure to the energy 34 radiated from the sun 32. In addition, sun light 36 may reflect off an adjacent glass product 38 at a grazing angle onto the vinyl siding 30. This results in a near doubling of the solar exposure on the vinyl siding. The inside corner condition occurs when the sun's rays reflect off a glass product at a very small grazing angle. In this scenario, the solar energy is generally reflecting off the first surface (i.e. outer surface of the exterior lite of glass) of an insulating glass unit 38.

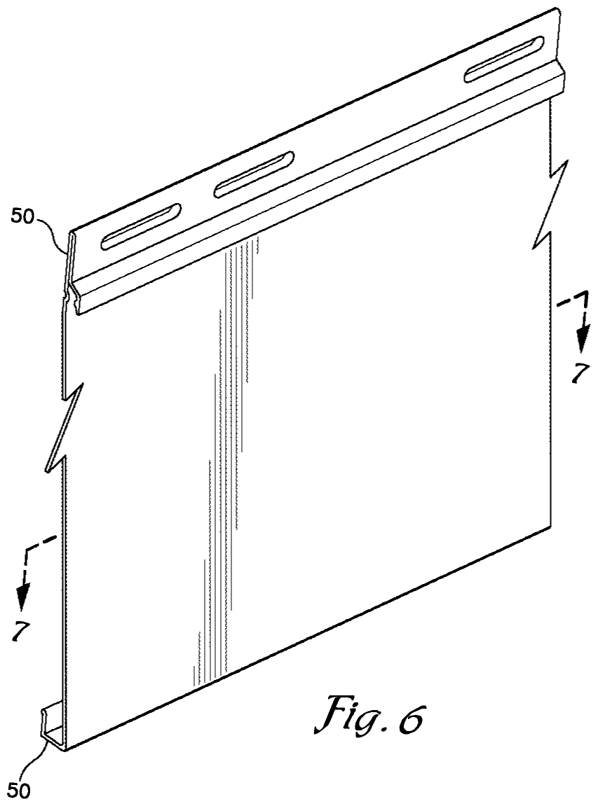

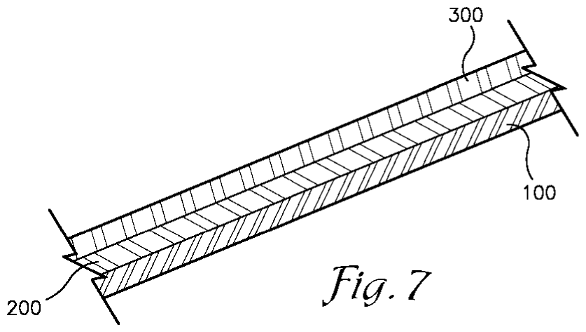

FIG. 6 is a segment of a vinyl siding panel incorporating the technology disclosed herein. FIG. 7 is a cross sectional view of the siding panel taken along line 7-7 in FIG. 6 detailing the three layers comprising the panel that are more fully discussed below.

Traditional Vinyl Siding Configuration and Formulation

Vinyl siding is generally manufactured by co-extrusion. In a typical panel extrusion process, two layers of PVC are laid down in a continuous extrusion process; the top layer is a weatherable capstock, which comprises about a tenth to a third of the siding thickness. This capstock generally includes about 10% titanium dioxide, which, as discussed above, is a pigment and provides resistance to breakdown from UV light. As also discussed above, vinyl siding, like paint, will inevitably fade over time, but the fade rate is somewhat slower with vinyl, and in any house cladding (vinyl, paint or others) the intensity of the color is in direct correlation to the rate of fade. For example, two currently popular colors are “barn red” and “clay”. In reaction to sunlight, the barn red will fade faster than the very neutral clay color whether paint, vinyl siding or other composition.

The lower layer, known as the substrate, is typically about 15% ground limestone (which is largely calcium carbonate). The introduction of limestone reduces cost, and also balances the titanium dioxide, keeping both extrusion streams equally fluid during manufacturing. A small quantity of tin mercaptan or butadiene is added as a stabilizer to chemically tie up any hydrochloric acid that is released into the PVC material as the siding ages. Lubricants are also added to aid in the manufacturing process.

Configuration and Formulation of Heat Buildup and Fade Resistant Siding

Disclosed herein are modifications to the typical formulations and number of layers found in vinyl siding. The disclosed extrudate panel utilizes a mid-layer 200 of a specially formulated polyvinylidene difluoride (PVDF) applied to the surface of the capstock layer 300. The capstock layer 300 is disposed closest to the wall of the structure to which the vinyl siding is applied. PVDF is a specialty plastic material in the fluoropolymer family; it is used generally in applications requiring the highest purity, strength, and resistance to solvents, acids, bases and heat and low smoke generation during a fire event. Compared to other fluoropolymers, it has an easier melt process because of its relatively low melting point of around 177° C. The top exposed weathering layer 100 allows for 5% translucency and this increased translucency allows more solar energy to penetrate the exterior facing layer 200 and dissipate back into the atmosphere. The benefit of this improvement is lowering the infrared radiation load on the PVC (Polyvinyl Chloride) capstock layer 300 resulting in lowered temperature build and less chance of surface distortion.

PVDF is a fluorocarbon and is classified as “Self-Extinguishing, Group 1” by Underwriters' Laboratories, Inc. The key benefits of the material for purposes of a vinyl siding application are its: low weight, low thermal conductivity, high chemical corrosion resistance, heat resistance, mechanical strength and toughness, high abrasion resistance, resistant to most chemicals and solvents, the material is very hydrophilic resistant and is unaffected by long-term exposure to ultraviolet radiation.

A PVDF resin and pigment impregnated backer film, such Kynar® produced by E.I. DuPont de Nemours and Co., is laid atop the top layer 200 of the panel. A thin layer of resins and pigments are released and transferred from the backer film to the surface of the top layer 200. The resins and pigments preferably measure in the range of about 0.0005 to 0.001 inches in thickness. As the transfer film is peeled away from the top layer a newly deposited layer 100 is now in position. The newly applied layer of resins and pigments is now the first layer 100, positioned atop what was previously defined as the top layer and which is now termed the second layer 200.

The second layer 200 is also formulated differently than traditional vinyl siding in an effort to reduce heat build-up and color fade. The second layer 200, as disclosed herein, is comprised of polyvinyl chloride and additives to include titanium dioxide. The formulation of titanium dioxide utilized in the second layer is comprised of a wide range of particle sizes and shapes resulting in both reflection and scattering of the incoming light. This reflection and scattering of infrared light greatly facilitates the transfer of heat away from the panel.

The formulation of pigments that possess larger median particle size and greater diversity of size distributions than those of conventional titanium dioxide are comingled with conventional titanium dioxide pigments to optimize the visible reflectance, as well as the near-infrared reflectance. Both visible reflectance and near infrared reflectance increase as the pigment particle size increases. The main reflection band of the coatings shifts farther into the near infrared region with increasing pigment particle size. The titanium dioxide formulation utilized constitutes in the range of about 5-15% of the weight of the second layer.

The third layer 300 positioned beneath the second layer is formulated using polyvinyl chloride in the range of about 60-70 percent by weight and poly(a-methylstyrene-styrene-acrylonitrile) in the range of about 20-30 percent by weight. The third layer 300 has a thickness in the range of about 0.032 to 0.044 inches.

The disclosed embodiment of the heat build-up and color fade resistant polymer extrudate panel comprises a highly opaque, up to 99%, first pigment and resin layer that has been film transfer bonded to the second polymer layer 200. As detailed above, a third polymer layer 300 resides beneath the second polymer layer, wherein the panel exhibits an L* value of less than 40, a heat build-up of less than 50° F. and the ΔE of the panel does not exceed 1 color unit after five years of outdoor weathering. The susceptibility of various colors and siding layer compositions to heat build-up can be tested according to the procedures outlined at ASTM D4803.

Many different arrangements of the various components depicted, as well as components not shown, are possible without departing from the spirit and scope of the disclosed technology. Embodiments of the disclosed technology have been described with the intent to be illustrative rather than restrictive. Alternative embodiments will become apparent to those skilled in the art that do not depart from its scope. A skilled artisan may develop alternative means of implementing the aforementioned improvements without departing from the scope of the disclosed technology.

It will be understood that certain features and sub combinations are of utility and may be employed without reference to other features and sub combinations and are contemplated within the scope of the claims. Not all steps listed in the various figures need be carried out in the specific order described.

We claim:

1. A heat build-up and fade resistant extrudate panel, the panel comprising:
a first, exterior facing, polymer layer of a formulation of polyvinylidene difluoride that is in the range of about 90-99% opaque;
a second layer comprising a formulation of polyvinyl chloride and additives; and
a third layer disposed beneath the second layer wherein the third layer is comprised of a formulation in the range of about 60-70% by weight polyvinyl chloride and in the range of about 20-30% by weight poly(a-methylstyrene-styrene-acrylonitrile).

2. The heat build-up and fade resistant extrudate panel of claim 1, wherein the panel exhibits a predicted heat build-up of less than about 50° F.

3. The heat build-up and fade resistant extrudate panel of claim 1, wherein the first polymer layer has a thickness in the range of about 0.0005 inches to 0.001 inches.

4. The heat build-up and fade resistant extrudate panel of claim 1, wherein the formulation additives of the middle layer are a combination of titanium dioxide particle sizes for substantially reflecting infrared light.

5. The heat build-up and fade resistant extrudate panel of claim 1, wherein the infrared reflecting titanium dioxide comprises in the range of about 5-15% of the weight of the second layer.

6. The heat build-up and fade resistant extrudate panel of claim 1, wherein the second layer has a thickness in the range of from 0.005 to 0.007 inches.

7. The heat build-up and fade resistant extrudate panel of claim 1, wherein the third layer is further comprised of calcium carbonate to enhance panel stiffness.

8. The heat build-up and fade resistant extrudate panel of claim 1, wherein the third layer has a thickness in the range of from 0.032 to 0.044 inches.

9. The heat build-up and fade resistant extrudate panel of claim 1, wherein the color change due to exposure to the environment does not exceed a ΔE of 1 color unit after five years of outdoor weathering, measured pursuant to ASTM D7856.

10. The heat build-up and fade resistant extrudate panel of claim 1, wherein the color change of the panel due to exposure to the environment does not exceed a ΔE of 2 color units after six or more years of outdoor weathering, measured pursuant to ASTM D7856.

11. The heat build-up and fade resistant extrudate panel of claim 1, wherein the heat build-up of the panel is measured pursuant to ASTM D4803 or ASTM WK47658.

12. The heat build-up and fade resistant extrudate panel of claim 1, wherein the L* value of the panel is determined pursuant to ASTM D2244.

13. The heat build-up and fade resistant extrudate panel of claim 1, wherein the ΔE of the panel is measured according to ASTM D7856.
